(19) United States
(12) Patent Application Publication
(10) Pub. No.: US 2004/0093828 A1
(43) Pub. Date: May 20, 2004

(54) Elevator cab door assembly with honeycomb core

(76) Inventors: Rory Stephen Smith, El Cajon, CA (US); Patrick M. Bass, Lakeside, CA (US)

Correspondence Address: WHITE & CASE LLP, PATENT DEPARTMENT, 1155 AVENUE OF THE AMERICAS, NEW YORK, NY, 10036, US

(21) Appl. No.: 10/300,862

(22) Filed: Nov. 20, 2002

(51) Int. Cl. B66B 13/02; E04C 2/34

(52) U.S. Cl. 52/793.1

(57) ABSTRACT

An elevator cab door having a honeycomb core comprises an elevator door frame adapted for attachment to the entryway of an elevator cab. The door frame has a front skin panel and a rear skin, and a core comprising a plurality of honeycomb cells sandwiched between the front and rear skins. The door assembly components, including the frame, core and the skins are formed from a light, strong material such as aluminum. The structure is lightweight, easily adaptable to varying opening and closing velocities, and less prone to imparting dangerous impact loads on passengers in case of hazardous situations.

### FIELD OF INVENTION

This invention relates to the field of door assemblies in elevator cabs in general, and in particular, to improvements in the mass, strength and impact resistance of door assemblies.

### BACKGROUND OF INVENTION

Safety considerations in elevator systems are of paramount importance. Closing doors in an elevator always pose the danger of people getting caught in between the doors. Even though doors usually slow down to a reduced speed in closing mode, it is recognized that a passenger attempting to walk through an elevator entrance when the doors are closing could be impacted with a blow directly proportional to the mass of the moving door. It is desirable, therefore, to have doors that are relatively light weight. It is also desirable to have elevator doors that are strong and resistant to facial and lateral impact as well as resistant to warping during shipping.

### SUMMARY OF INVENTION

The present invention involves an elevator door that is lightweight, resistant to impact and readily capable of absorbing impact energy as well as imparting minimal forces.

In one embodiment of the invention, an elevator door frame is adapted to attach to the entryway of an elevator cab. The door frame has a front skin and a rear skin. A core, comprising a plurality of honeycomb cells, is sandwiched between the front and rear skins. Each honeycomb cell, with relatively thin walls, may be of polygonal shape with its longitudinal axis oriented perpendicularly to the front and rear skins of the door. The skins of the door and the honeycomb cells comprise a lightweight material or metal, such as aluminum. The skins are adhered to the frame and to the core by any appropriate means, such as an adhesive. The door assembly therefore has a relatively low mass.

In another embodiment, an elevator cab and door assembly comprises an elevator cab having a cab entryway. A door frame is disposed in the entryway, and is moveable to opened and closed positions. A core, comprising a plurality of honeycomb cells, is sandwiched between front and rear skins attached to opposed sides of the door frame.

### BRIEF DESCRIPTION OF DRAWINGS

FIG. 1 shows a perspective view of the components of a door frame assembly according to an embodiment of the present invention.

FIG. 2A shows a detail of the honeycomb structure of the core of the door assembly in an embodiment of the present invention.

FIG. 2B shows the structure of a honeycomb cell of a core board in an embodiment of the present invention.

FIG. 3 shows the door assembly of the present invention disposed in the entryway of an elevator cab according to another embodiment of the present invention.

### DETAILED DESCRIPTION

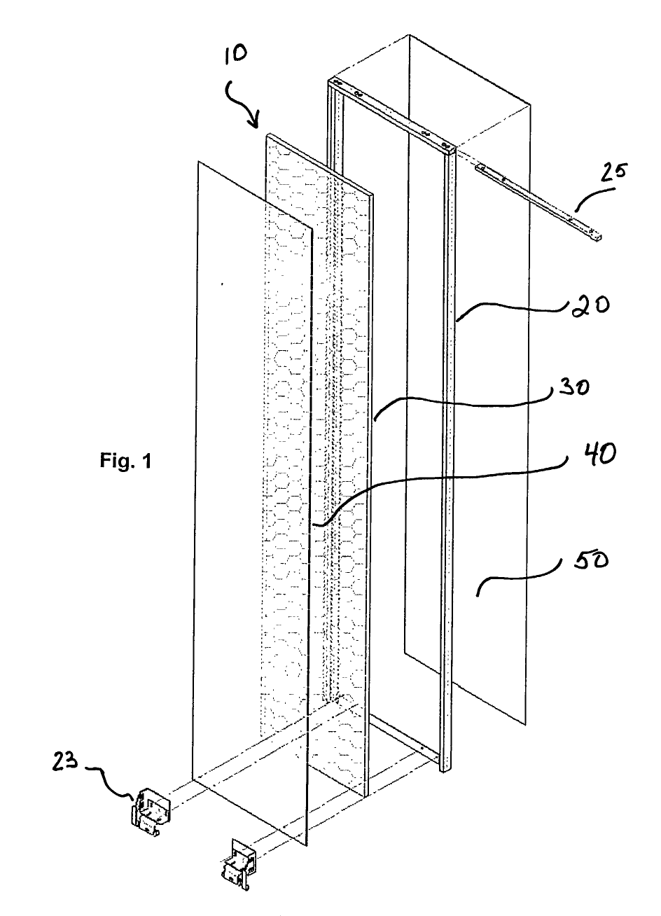

FIG. 1 shows a perspective view of the components of a door frame assembly 10 according to one embodiment of the present invention. Door frame 20 is constructed to receive core panel 30 sandwiched in between a front panel 40 and a rear panel 50. Front panel 40 and rear panel 50 form the outer and rear skins of the door frame after installation. The skins may be fastened to the core and the door frame using any suitable means, such as an adhesive (not shown).

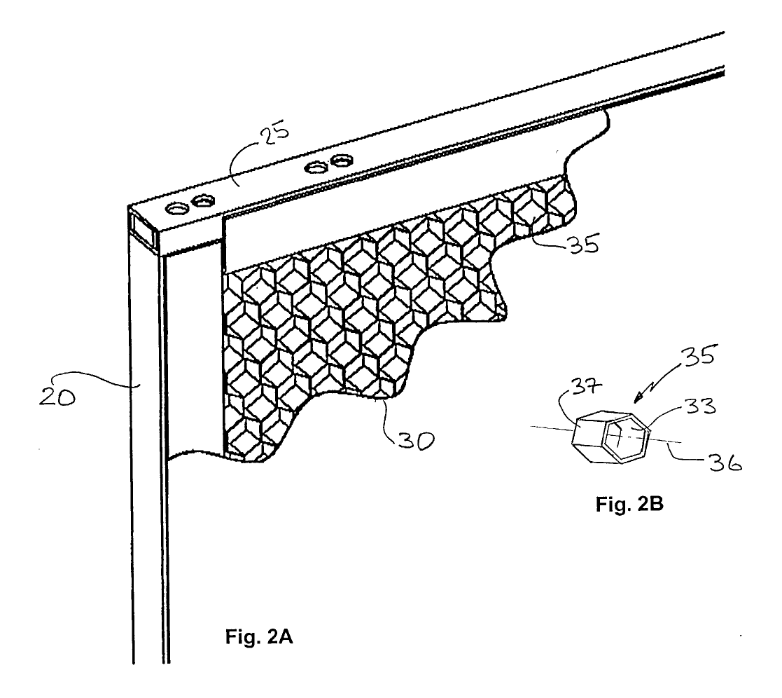

An enlarged view of a corner of the door frame is shown in FIG. 2A. Core board 30 is shown with a portion of the outer skin removed for better viewing of the various honeycomb cells 35. One of the honeycomb cells is shown in FIG. 2B. The cell has longitudinal axis 36 parallel to cell walls 37. In this embodiment, the longitudinal axis 36 of the cells is oriented perpendicularly to the door skins 40 and 50 when assembled into the door frame. In this orientation, the moment of inertia of the cell walls provides significant strength for the door frame. The shape of the cell is formed by cell walls 37, and the cross-sectional shape may be any form. For example, the shape of the cells may be selected from the group consisting of regular polygons, irregular polygons, circles, ellipses, and combinations thereof. The dimensions of the cells and the inner and outer skins will vary depending upon the particular situation or elevator installation. In one embodiment, the cross-sectional shape is hexagonal with a cross-sectional dimension of about 0.5 inches across and about 1.25 inches along the longitudinal dimension. The front and rear skins may have any thickness or size, and in one embodiment, may be about 0.032 inches thick, 121 inches high and 49 inches wide.

Any materials suitable for forming honeycomb cells and other components of the door frame may be used, without limitation, for the present invention. In one embodiment of the invention, the honeycomb cell, the door frame and the front and rear skins of the door are all made out of aluminum. Aluminum provides an overall lightweight door structure while the honeycomb geometry provides strength and controlled collapse for energy absorption during impact. The lightweight structure is easily adaptable to varying opening and closing velocities, and less prone to imparting dangerous impact loads to passengers who may unexpectedly find in between the doors when they are closing.

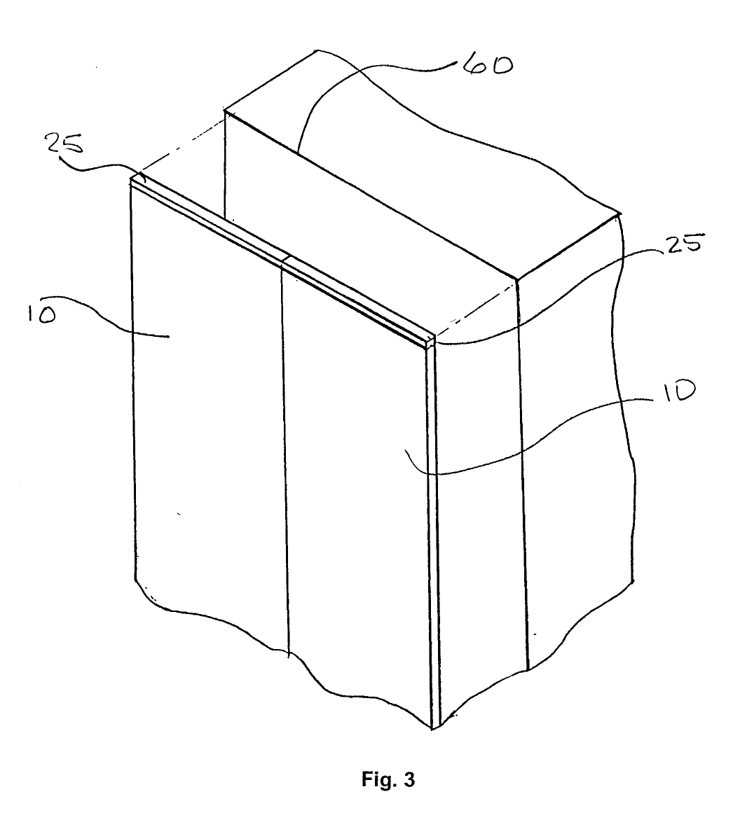

FIG. 3 shows entryway 60 of an elevator cab and door assembly 10. The door frame of the door assembly is adapted for attachment to the entryway. The attachment comprises door hanger assembly 25 fastened to an upper portion of the frame for supporting the door in the entryway of the elevator cab as shown in FIGS. 1, 2A and 3. The hanger assembly allows the doors to move to opened and closed positions in the entryway. In another aspect of the present embodiment, the door frame comprises door gib assembly 23 mounted to a lower portion of the frame for guiding the horizontal movement of the door, as better seen in FIG. 1.

The honeycomb core door of the present invention has several particular advantages over prior art doors. Most notably, the honeycomb door is significantly lighter in weight when compared to conventional doors of similar dimensions. Building codes governing elevator operations impose restrictions on the maximum kinetic energy levels that must not be exceeded by a door as it closes. The reduced weight of the door of the invention results in lower kinetic energy values when the door is moving. The light-weight door of the invention may, therefore, be operated at higher speeds with quicker closing times than conventional doors. The ability to open and close doors in less time advantageously improves the traffic handling capabilities of an elevator system. Studies have shown that for a given horsepower motor, a 22% reduction in car door weight can increase traffic handling capacity by 7%.

In addition, the lighter weight of the door also has advantages in modernization applications. When an elevator system is undergoing modernization, the overall weight of the entire system cannot be increased by more than 5% over the weight of the existing system. Therefore, the reduction in weight of the door of the present invention allows the manufacturer to have greater flexibility in modernizing the elevator system without violating the weight restrictions imposed by elevator operation codes.

While the invention has been particularly shown and described with reference to particular embodiments, those skilled in the art will understand that various changes in form and details may be made without departing form the spirit and scope of the invention.

What is claimed is:

1. An elevator cab door having a honeycomb core comprising:
an elevator door frame adapted for attachment to the entryway of an elevator cab, the door frame having a front skin and a rear skin; and
a core comprising a plurality of honeycomb cells sandwiched between the front and rear skins.

2. The elevator cab door according to claim 1, wherein each honeycomb cell has its longitudinal axis oriented perpendicularly to the front and rear skins.

3. The elevator cab door according to claim 2, wherein each honeycomb has a cross-sectional shape selected from the group consisting of regular polygons, irregular polygons, circles, ellipses, and combinations thereof.

4. The elevator cab door according to claim 3, wherein the cross-sectional shape is a hexagon.

5. The elevator cab door according to claim 4, wherein the door frame, front skin and rear skin comprise aluminum.

6. The elevator cab door according to claim 5, wherein the cells comprise aluminum.

7. The elevator cab door according to claim 6, wherein the front and rear door skins are adhered to the frame and to the core by an adhesive.

8. The elevator cab door according to claim 7, wherein the door frame comprises a door hanger assembly fastened to an upper portion of the door frame for supporting the door in the entryway of the elevator cab and for allowing the door to slide to opened and closed positions in the entryway.

9. The elevator cab door according to claim 8, wherein the door frame comprises a door gib assembly mounted to a lower portion of the frame for guiding the horizontal movement of the door.

10. The elevator cab door according to claim 9, wherein the door has a reduced mass when compared to a solid elevator door of similar dimensions.

11. An elevator cab and door assembly, comprising:
an elevator cab having a cab entryway;
a door frame disposed in the entryway, the door frame moveable to opened and closed positions,
a front door skin and a rear door skin attached to opposed sides of the door frame; and
a core comprising a plurality of honeycomb cells sandwiched between the front and rears skins.

12. The elevator cab and door assembly according to claim 11, wherein each honeycomb cell has its longitudinal axis oriented perpendicularly to the front and rear skins.

13. The elevator cab and door assembly according to claim 12, wherein each honeycomb cell has a cross-sectional shape selected from the group consisting of regular polygons, irregular polygons, circles, ellipses, and combinations thereof.

14. The elevator cab and door assembly according to claim 13, wherein the cross-sectional shape is a hexagon.

15. The elevator cab and door assembly according to claim 14, wherein the door frame, front skin and rear skin comprise aluminum.

16. The elevator cab and door assembly according to claim 15, wherein the cells comprise aluminum.

17. The elevator cab according to claim 16, wherein the front and rear door skins are adhered to the frame and to the core by an adhesive.

18. The elevator cab and door assembly according to claim 17, wherein the door frame comprises a door hanger assembly fastened to an upper portion of the door frame for supporting the door in the entryway of the elevator cab and for allowing the door to slide to opened and closed positions in the entryway.

19. The elevator cab and door assembly according to claim 18, wherein the door frame comprises a door gib assembly mounted to a lower portion of the door frame for guiding the horizontal movement of the door.

20. The elevator cab and door assembly according to claim 19, wherein the door has a reduced mass when compared to a solid elevator door of similar dimensions.
